(19) United States
(12) Patent Application Publication
(10) Pub. No.: US 2013/0271880 A1
(43) Pub. Date: Oct. 17, 2013

(54) PROTECTION CIRCUIT FOR FAN

(71) Applicants: Yuan-Xi CHEN, Shenzhen City (CN); Ying-Bin FU, Shenzhen City (CN)

(72) Inventors: Yuan-Xi CHEN, Shenzhen City (CN); Ying-Bin FU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/572,655

(22) Filed: Aug. 12, 2012

(30) Foreign Application Priority Data
Apr. 12, 2012 (CN) 201210106161.X

(51) Int. Cl. H02H 5/04

(52) U.S. Cl. 361/24

(57) ABSTRACT

A protection circuit includes first and second field-effect transistors (FETs), a bipolar junction transistor, first to sixth resistors, and a first capacitor. The protecting circuit is connected between a power supply unit and a fan, for powering on or powering off the fan.

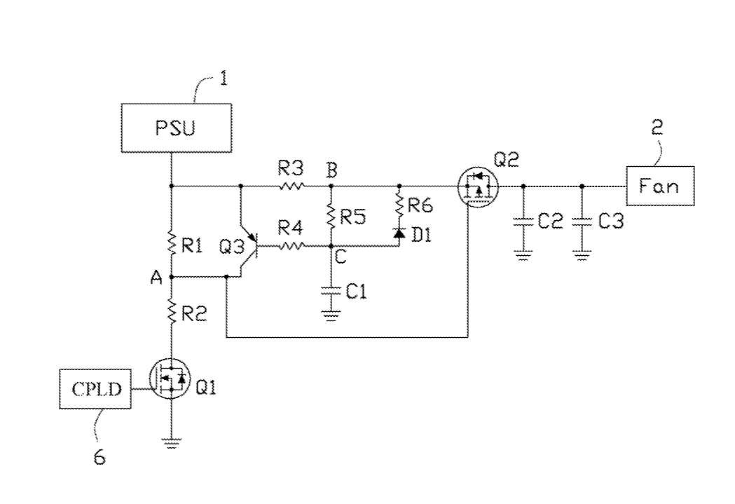

### BACKGROUND

1. Technical Field

The present disclosure relates to a circuit for protecting a fan.

2. Description of Related Art

Overheating is a major issue for electronic devices. For electronic devices where a fan is used to dissipate heat, if the fan fails, the electronic device may be damage from the resultant overheating. Besides physical failures, a fan may also fail electronically, such as due to overcurrent. Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments. Moreover, in the drawing, like reference numerals designate corresponding parts throughout the several views.

The FIGURE is a circuit diagram of an exemplary embodiment of a protection circuit.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

Referring to the FIGURE, an exemplary embodiment of a protection circuit is shown. The protection circuit includes two field-effect transistors (FETs) Q1 and Q2, a bipolar junction transistor (BJT) Q3, six resistors R1-R6, three capacitors C1-C3, and a diode D1. The protection circuit is connected between a power supply unit (PSU) 1 and a fan 2. When a current flowing through the fan 2 is too great, the protection circuit disconnects the PSU 1 from the fan 2. In the embodiment, the FET Q1 is an n-channel FET, the FET Q2 is a p-channel FET, and the transistor Q3 is a pnp type BJT.

An output of the PSU 1 is connected to a drain of the FET Q1 through the resistors R1 and R2 connected in series. A gate of the FET Q1 is connected to a complex programmable logic device (CPLD) 6, for receiving an enable signal from the CPLD 6. A source of the FET Q1 is grounded. A node between the resistors R1 and R2 is connected to a collector of the BJT Q3. The node between the resistors R1 and R2 is further connected to a gate of the FET Q2. The enable signal from the CPLD 6 is to control the fan 2.

An emitter of the BJT Q3 is connected to the output of the PSU 1. The emitter of the BJT Q3 is further connected to a first end of the resistor R3. A base of the BJT Q3 is grounded through the resistor R4 and the capacitor C1 connected in series. A node between the resistor R4 and the capacitor C1 is connected to a second end of the resistor R3 through the resistor R5. The node between the resistor R4 and the capacitor C1 is also connected to an anode of the diode D1. A cathode of the diode D1 is connected to a source of the FET Q2 through the resistor R6. A drain of the FET Q2 is grounded through the capacitors C2 and C3 connected in parallel. The drain of the FET Q2 is further connected to the fan 2 for transmitting power from the PSU 1 to the fan 2. In the embodiment, the node between the resistors R1 and R2 is marked as point A. The second end of resistor R3 is marked as point B. The node between the resistor R4 and the capacitor C1 is marked as point C.

When the fan 2 does not need to operate, the CPLD 6 outputs the enable signal with a low level, such as logic 0. The FET Q1 is turned off. A voltage at the point A is 12 volts. A voltage at the point B is 12 volts. A voltage at the gate of the FET Q2 is 12 volts, and a voltage at the source of the FET Q2 is 12 volts. In other words, if a voltage difference Vgs between the gate and the source of the FET Q2 is equal to zero; the FET Q2 is turned off. The fan 2 receives no power. Meanwhile, the PSU 1 charges the capacitor C1 through the resistors R3 and R5. When the capacitor C1 is charged to full, a voltage at the point C is 12 volts.

When the fan 2 needs to operate, the CPLD 6 outputs the enable signal with a high level, such as logic 1. The FET Q1 is turned on. Because a resistance of the resistor R1 is equal to a resistance of the resistor R2, a voltage at the point A is 6 volts. When a current flowing through the fan 2 is less than or equal to a rating of the fan 2 (for example, the current is less than or equal to one ampere), a voltage at the point B is about 11.5 volts (in the embodiment, a resistance of the resistor R3 is 0.5 ohms) Moreover, the voltage at the point A is 6 volts, so the voltage at the gate of the FET Q2 is 6 volts. The difference voltage Vgs between the gate and the source of the FET Q2 is less than zero. The FET Q2 is turned on. The PSU 1 provides power for the fan 2.

In addition, the voltage at the point C is 12 volts, and the voltage at the point B is 11.5 volts, such that the diode D1 is turned on. The capacitor C1 is discharged through the resistor R6. When the voltage at the point C is equal to the voltage at the point B, the capacitor C1 stops discharging.

When the current flowing through the fan 2 is greater than the rating (for example, the current is 1.4 amperes), a voltage difference between two ends of the resistors R3 is 0.7 volts. In other words, the voltage at the point B is 11.3 volts. Because of the capacitor C1, the voltage at the point C is 11.3 volts. As a result, because a resistance of the resistor R4 is little, a voltage at the base of the transistor Q3 is about 11.3 volts. Furthermore, a voltage at the emitter of the transistor Q3 is 12 volts, such that a voltage difference between the emitter and the base of the transistor Q3 is 0.7 volts. The transistor Q3 is turned on. In this condition, a voltage at the collector of the transistor Q3 is 12 volts, such that the voltage at the gate of the FET Q2 is 12 volts. Because the voltage at the point B is 11.3 volts, a voltage difference between the gate and the source of the FET Q2 is greater than zero. The FET Q2 is turned off. The fan 2 is powered off.

When the current flowing through the fan 2 is reduced, the voltage at the point B is increased. In this condition, the capacitor C1 is charged. When a voltage difference between two ends of the capacitor C1 is greater than 11.3 volts, a voltage difference between the emitter and the base of the transistor Q3 is less than 0.7 volts. The transistor Q3 is turned off. The voltage at the point A is 6 volts. The FET Q2 is turned on, such that the fan 2 is powered on.

The foregoing description of the exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A protection circuit connected between a power supply unit (PSU) and a fan, the protection circuit comprising:
first to sixth resistors;
a first capacitor;
first and second field-effect transistors (FETs) each comprising a gate, a drain, and a source, wherein the drain of the first FET is connected to the PSU through the first and second resistors connected in series, the gate of the first FET is connected to a complex programmable logic device (CPLD), the source of the first FET is grounded;
a diode; and
a bipolar junction transistor comprising a base, a collector, and an emitter, wherein the collector is connected to a node between the first and second resistors, and connected to the gate of the second FET, the emitter is connected to the PSU and a first end of the third resistor, the base is grounded through the fourth resistor and the first capacitor connected in series, a node between the fourth resistor and the first capacitor is connected to a second end of the third resistor through the fifth resistor, the node between the fourth resistor and the first capacitor is further connected to an anode of the diode, a cathode of the diode is connected to the source of the second FET through the sixth resistor, the drain of the second FET is connected to the fan.

2. The protection circuit of claim 1, wherein a resistance of the first resistor is equal to a resistance of the second resistor.

3. The protection circuit of claim 1, wherein a resistance of the third resistor is 0.5 ohms.

4. The protection circuit of claim 1, wherein the drain of the second FET is further grounded through a second capacitor.

5. The protection circuit of claim 4, further comprising a third capacitor connected to the second capacitor in parallel.
